(19) United States
(12) Patent Application Publication
(10) Pub. No.: US 2026/0022052 A1
(43) Pub. Date: Jan. 22, 2026

(54) HOLLOW CORE OPTICAL FIBRE DRAWING METHOD WITH MODIFIED DRAWDOWN

(71) Applicant: University of Southampton, Redmond, WA (US)

(72) Inventors: Thomas David BRADLEY, Redmond, WA (US); Francesco POLETTI, Redmond, WA (US); Gregory Teofil JASION, Redmond, WA (US); Ian Alexander Kelso DAVIDSON, Redmond, WA (US); Gregory Johannes Norman JACKSON, Redmond, WA (US)

(73) Assignee: University of Southampton, Redmond, WA (US)

(21) Appl. No.: 18/993,657

(22) PCT Filed: Jun. 16, 2023
(86) PCT No.: PCT/US2023/025500

§ 371 Date: Jan. 13, 2025

(30) Foreign Application Priority Data
Jul. 14, 2022 (GB) 2210361.8

(51) Int. Cl. C03B 37/027; G02B 6/032

(52) U.S. Cl. CPC C03B 37/02781; C03B 2203/16; G02B 6/032

(57) ABSTRACT

A method of fabricating a hollow core optical fibre comprises: providing an initial preform formed from glass and having a transverse cross-sectional structure configured to form, in an optical fibre drawn from the preform, a transverse cross-sectional structure comprising a hollow core surrounded by a plurality of voids defining a microstructured cladding; heating an end portion of the preform; drawing a length of intermediate cane from the softened glass of the preform, via a first neckdown, the cane having a glass cross-sectional area less than the glass cross-sectional area of the preform; heating a portion of the cane spaced from the first neckdown, the cane remaining unitary with the preform; and drawing a length of hollow core optical fibre from the softened glass of the cane, via a second neckdown, the hollow core optical fibre having a glass cross-sectional area less than the glass cross-sectional area of the cane.

### BACKGROUND OF THE INVENTION

The present invention relates to a method for drawing hollow core optical fibres, the method having a modified draw down.

Optical fibres conventionally are of a solid core design, comprising a core of solid glass surrounded by a cladding of solid glass of a lower refractive index than the core. Light is guided along the core by total internal reflection at the core-cladding boundary. Solid core fibres are fabricated by a fibre drawing process, in which a short glass preform having a cross-sectional structure matching the intended refractive index profile of the finished fibre, but with a width many times that of the finished fibre, is lowered axially into an annular furnace which heats and softens the glass. The softened glass is then pulled or drawn from an end of the preform, either under gravity or with tensioning, to a decreased width for the finished fibre, which is wound onto a spool. In some processes, a cane of narrower width is firstly drawn from the preform, and separated from the preform to be drawn into the fibre at a later time. The process of drawing from a preform to cane to narrow the width of the glass structure is referred to as drawdown.

In recent years, hollow core optical fibres have been developed. These have a central longitudinal hole or void defining a hollow core, which is surrounded by a cladding typically comprising a plurality of smaller longitudinal holes or voids in a specified geometry, which may be referred to as a microstructure. Light is guided along the hollow core by one of several mechanisms, depending on the geometry of the microstructured cladding. Hollow core fibres are attractive owing to superior optical propagation characteristics compared with solid core fibres, including reduced optical propagation loss (attenuation), increased propagation speed, larger optical bandwidth and reduced parasitic nonlinear optical effects, which stem from the large fraction of air inside the fibre and corresponding reduced amount of glass. Light propagates mainly in air, thereby avoiding detrimental effects arising from propagation in glass. Hollow core fibres can also be made by fibre drawing methods, starting from a preform (optionally drawn into a cane) formed with the desired cross-sectional profile of voids. In order to achieve the desired geometrical structure of the core and cladding in the finished fibre (which needs to be precise for position, void size, and thickness of glass membranes between voids) for accessing the intended optical properties of the particular fibre design, pressure is typically applied to the voids during drawing of the fibre from the preform or the cane. The pressurisation counteracts surface tension in the softened glass which otherwise tends to cause collapse of the voids and destruction of the intended structure.

Fibre drawing can be measured by a parameter known as the drawdown ratio. This is the ratio of glass cross-sectional area in the preform to the glass cross-sectional area in the fibre, where the relevant cross-section is transverse to the longitudinal axis of the glass structure (namely the preform, the fibre, and as discussed later, a cane). It equates to the number of metres of fibre that can be drawn per metre of preform, so that a high drawdown ratio is desirable. A larger preform contains a larger volume of glass so would be expected to yield more fibre. For a given volume of glass, the preform size might be increased by increasing the preform width [1], which suggests a higher drawdown ratio (more glass available per metre of preform), or by increasing the preform length, which reduces the drawdown ratio (less glass available per metre of preform). For hollow core fibres, however, the dynamics of the pressurisation are more complex and difficult to control when drawing a wide preform into a narrow fibre, since the changes in the outer diameter and the diameter of the holes are more extreme. Accordingly, high drawdown ratios are typically unsuitable or even unachievable for hollow core fibre fabrication. Hence, a narrower preform and correspondingly lower drawdown ratio are generally required for successful hollow core fibre fabrication, giving a smaller fibre yield and corresponding inefficiency in fibre production. However, pressurisation can be more difficult to implement with a narrower preform since the voids are smaller and harder to access; this can decrease the structural quality of the finished fibre. Hence there are a number of factors which inhibit efficient high volume fabrication of quality hollow core optical fibre. The cost of hollow core fibre is therefore high and maximum achievable lengths of fibre are limited, compared with solid core fibre. These factors are particularly detrimental in view of the excellent optical properties of hollow core fibres which make them highly attractive for many applications, including long-distance telecommunications for which very long lengths of inexpensive fibre are desirable.

Telecommunication methods typically propagate light at infrared wavelengths, where attenuation in glass is low. Optical fibres configured to propagate visible and ultraviolet light are also of interest, for applications including quantum computing, Raman spectroscopy, photochemistry and wastewater contaminant detection. In solid core fibres of silica glass, exposure to ultraviolet light creates permanent defects in the glass structure, leading to increased attenuation. Hollow core fibres are less susceptible to this damage owing to the decreased light-glass interaction, and therefore are good candidates for propagation of light at short optical wavelengths. However, the wavelengths which a hollow core fibre can propagate at low loss depend on the precise geometry of the core and cladding. Shorter wavelengths can be most effectively propagated with a wide bandwidth by using thinner glass membranes around the voids of the cladding. Thinner membranes are more difficult to fabricate because pressurisation regimes able to effectively counter surface tension effects during drawing are harder to implement for thinner glass. The overall fibre structure is also smaller for shorter wavelengths, suggesting the need for a larger drawdown ratio, which as noted above is problematic for hollow core fibre fabrication.

Hence, there are a range of difficulties in hollow core optical fibre production that tend to limit achievable fibre length and wavelength performance, reduce efficiencies, and increase complexity and cost.

Accordingly, approaches that improve the fabrication of hollow core optical fibres are of interest.

### SUMMARY OF THE INVENTION

Aspects and embodiments are set out in the appended claims.

According to a first aspect of certain embodiments described herein, there is provided a method of fabricating a hollow core optical fibre, the method comprising: providing an initial preform formed from glass and having a transverse cross-sectional structure configured to form, in an optical fibre drawn from the initial preform, a transverse cross-sectional structure comprising a hollow core surrounded by a plurality of voids defining a microstructured cladding, the initial preform having a first glass cross-sectional area; heating an end portion of the initial preform in order to soften the glass of the end portion; drawing a length of intermediate cane from the softened glass of the initial preform, via a first neckdown, the intermediate cane having a second glass cross-sectional area less than the first glass cross-sectional area; heating a portion of the intermediate cane spaced from the first neckdown in order to soften the glass of the portion, the intermediate cane remaining unitary with the initial preform; and drawing a length of hollow core optical fibre from the softened glass of the intermediate cane, via a second neckdown, the hollow core optical fibre having a third glass cross-sectional area less than the second glass cross-sectional area.

According to a second aspects of certain embodiments described herein, there is provided a hollow core optical fibre fabricated using a method according to the first aspect.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a transverse cross-sectional view of a first example hollow core optical fibre which may be fabricated according to example methods of the present disclosure;

FIG. 2 shows a transverse cross-sectional view of a second example hollow core optical fibre which may be fabricated according to example methods of the present disclosure;

FIG. 3 shows a transverse cross-sectional view of a third example hollow core optical fibre which may be fabricated according to example methods of the present disclosure;

FIG. 4 shows a graph of fibre capillary diameter against applied differential pressure for a modelled fibre drawing process according to conventional methods in which a fibre is drawn directly from a preform;

FIG. 5 shows a graph of fibre capillary diameter against applied differential pressure for a modelled example fibre drawing process according to the present disclosure, for the same fibre and preform as the FIG. 4 model.

FIGS. 6(a)-6(c) show schematic representations of steps of fibre drawing in a draw tower according to an example method of present disclosure; and

FIG. 7 shows a flow chart of steps in an example fibre drawing method according to the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of devices and methods discussed herein which are not described in detail may be implemented in accordance with any conventional techniques for implementing such aspects and features.

The present disclosure proposes methods for the fabrication of hollow core optical fibres aimed at addressing some of the issues with known methods with a view to providing improved fibre yield and enhanced fibre structures.

Hollow core optical fibre has a core in which light is guided that comprises a central longitudinal hole or void (commonly filled with air, but alternatively with another gas or mixture of gases, or a vacuum), surrounded by a cladding comprising a structured arrangement of longitudinal holes, voids or capillaries extending along the fibre length (microstructure). The absence of a solid glass core reduces the proportion of a guided optical wave that propagates in glass compared to that in a solid core fibre, offering benefits such as increased propagation speed, reduced loss from both absorption and scattering, and reduced nonlinear interactions. These properties make hollow core optical fibre very attractive for use many applications. These include optical telecommunications systems. However, it is presently difficult to manufacture hollow core optical fibre in the long lengths which are desirable for telecommunications systems, in which data centres between which optical data is transmitted may be tens or hundreds of kilometres apart. For example, the longest reported single span of hollow core fibre with a reasonable propagation loss figure (4-5 dB/km) of which the inventors are aware is only 12 km [2], while other reports show 14 km can be made with 10 dB/km loss [3]. At shorter wavelength operation, requiring a thinner membrane structure to define the cladding holes, only very much shorter lengths have been achieved, such as 33.6 m [4].

Hollow core optical fibres can be categorised according to their mechanism of optical guidance into two principal classes or types: hollow core photonic bandgap fibre (HCPBF, alternatively often referred to as hollow core photonic crystal fibre, HCPCF), and antiresonant hollow core fibre (AR-HCF or ARF). There are various subcategories of ARFs characterised by their geometric structure, including kagome fibres, nested antiresonant nodeless fibres (NANFs) and tubular fibres. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the terms “hollow core optical fibre” and “hollow core fibre” are used interchangeably and intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

FIG. 1 shows a schematic transverse cross-sectional view of an example HCPBF 10. In this fibre type, a structured, inner, cladding 1 comprises a regular closely packed array of many small glass capillaries, from which a central group is excluded to define a substantially circular hollow core 2. The periodicity of the cladding structure provides a periodically structured refractive index and hence a photonic bandgap effect that confines the propagating optical wave towards the core. This is the fundamental optical mode or fundamental mode (FM). One or more higher-order optical modes or higher-order modes (HOMs) may be supported in the core 2 and/or the cladding 1 These fibres can be described in terms of the number of cladding capillaries or “cells” which are excluded to make the core 2. In the FIG. 1 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the cladding. An outer cladding or jacket 3 surrounds the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF, to give a structure lacking any high degree of periodicity so that photonic bandgap effects are not significant. Rather, antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes, comprising the fundamental mode and one or more higher-order modes. The structured cladding can also support cladding modes able to propagate primarily inside the capillaries, in the glass of the capillary walls or in the spaces or interstices between the cladding capillaries and the fibre's outer cladding. The loss of these additional higher-order non-core guided modes is generally very much higher than that of the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss.

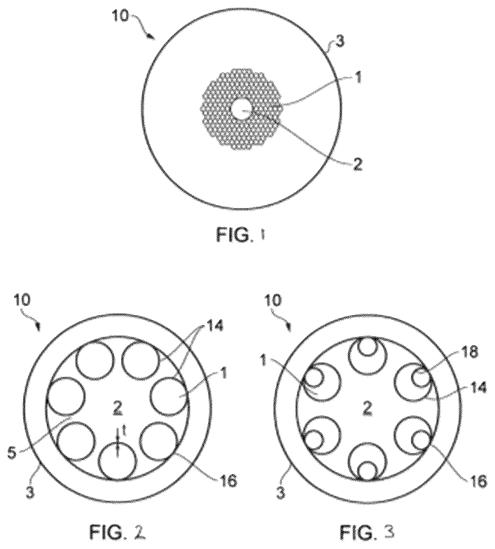

FIG. 2 shows a schematic transverse cross-sectional view of an example simple antiresonant hollow core fibre. The fibre 10 has an outer tubular cladding or jacket 3. A structured, inner, cladding 1 comprises a plurality of tubular cladding capillaries 14, in this example seven capillaries of the same cross-sectional size and shape, which are arranged inside the outer cladding 3 in a single ring, so that the longitudinal axes of each cladding capillary 14 and of the outer cladding 3 are substantially parallel. Each cladding capillary 14 is in contact with (bonded to) the inner surface of the outer cladding 3 at an azimuthal location 16, such that the cladding capillaries 14 are evenly spaced around the inner circumference of the outer cladding 3, and are also spaced apart from each other by gaps 5 (there is no contact between neighbouring capillaries). In some designs of ARF, the cladding tubes 14 may be positioned in contact with each other (in other words, not spaced apart as in FIG. 2), but spacing to eliminate this contact improves the fibre's optical performance and is generally preferred. The spacing 5 removes nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength bandwidth for which antiresonant optical guiding occurs in the ARF.

FIG. 2 shows merely one example of an ARF, and many other ARF structures are known.

FIG. 3 shows a schematic transverse cross-sectional view of a second example ARF. The ARF has a structured inner cladding 1 comprising six cladding capillaries 14 evenly spaced apart around the inner surface of a tubular outer cladding 3 and surrounding a hollow core 2. Each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs, where “double nested antiresonant nodeless fibre” or DNANF, refers to fibres including tertiary nested capillaries.

Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core may be for example, four, five, six, seven, eight, nine or ten, although other numbers are not excluded. The ring of cladding capillaries in an ARF creates a core boundary which has a shape comprising a series of adjacent inwardly curving surfaces (that is, convex from the point of view of the core). This contrasts with the usual outward curvature of the core-cladding interface in a conventional solid core fibre, and the substantially circular core boundary of a HCPBF (see FIG. 1). Accordingly, antiresonant hollow core fibres can be described as negative curvature fibres. The kagome category of ARF can also be configured as negative curvature fibres, and has a structured cladding of multiple small capillaries in an array, similar to HCPBF, but not configured to provide photonic bandgaps. In contrast to HCPBF, the guidance mechanism operates by antiresonance effects. Other examples of ARF include designs having claddings formed as a conjoined tube structure [5], and as a hemispherical tube structure [6].

Herein, the terms hollow core optical fibre, hollow core fibre, hollow core waveguide, hollow core optical waveguide and similar terms are intended to cover optical waveguiding structures configured according to any of the above examples and similar structures, where light is guided by any of several guidance mechanisms (photonic bandgap guiding, antiresonance guiding, and/or inhibited coupling guiding) in a hollow elongate void or core surrounded by a structured cladding comprising a plurality of longitudinal capillaries. The capillaries comprise or define elongate holes, voids, lumina, cells or cavities which run continuously along the length or longitudinal extent of the optical fibre, substantially parallel to the elongate core which also extends continuously along the fibre's length. These various terms may be used interchangeably in the present disclosure.

The hollow core fibre fabrication methods proposed herein are applicable to all and any types of hollow core optical fibre, as described above. As a particular example, fabrication of an antiresonant hollow core optical fibre with a single ring of un-nested cladding capillaries will be considered in detail, such as the example of FIG. 2. While the proposed methods can improve hollow core fibre fabrication for all fibre types, a particular benefit is the enhanced fabrication of anti-resonant fibres configured for guiding light at shorter optical wavelengths, by which is meant visible wavelengths and in particular ultraviolet wavelengths, which are not readily producible using conventional optical fibre drawing techniques. The proposed methods enable the very thin cladding membranes required for antiresonance of short wavelengths to be produced, in addition to offering improved yield and longer lengths for hollow core fibres in general. For example, kilometre scale yields of antiresonant hollow core fibre configured for broadband propagation at ultraviolet and visible wavelengths of light are achievable, and similar order or orders of magnitude improvement in yield is offered for fibres configured for near-infrared light propagation, required for telecommunications applications.

The proposed methods utilise modifications to a fibre drawing process that enable hollow core fibre fabrication at a higher overall drawdown ratio than is conventionally workable, leading to an increased fibre yield. In other words, hollow core fibres can be successfully produced from relatively wider preforms or canes than previously. In some examples, hollow core fibre configured for infrared wavelength propagation can be drawn from wider preforms or canes than are ordinarily used for such fibres; wider preforms or canes being conventionally prohibited by the high drawdown ratio. This offers an increased yield of fibre per draw, giving higher production efficiency and offering much longer continuous fibre lengths. In other examples, hollow core fibre configured for visible or ultraviolet propagation can be drawn from preforms or canes designed for infrared fibre production, which would ordinarily also be prohibited by the high drawdown ratio. The provision and use of narrower preforms to reduce the drawdown ratio for these finer and more delicate fibres under conventional drawing is complex, so again production efficiency is enhanced, and greater fibre lengths can be drawn.

The proposed methods are modified compared to a conventional drawing process by the introduction of one (or more) additional draw stages to introduce at least one intermediate preform or cane width between an initial preform or cane (where a cane is conventionally prepared by drawing down a preform to a narrower width and separating it from the preform) and the finished fibre. Unlike a conventional fibre fabrication process, in which a preform is drawn into a narrower cane which is separated from the preform in a convenient length and then separately drawn itself to produce the fibre from the cane, the proposed method does not separate the intermediate cane from the initial preform or cane before the intermediate cane is drawn into the fibre. Thus, the overall drawdown ratio from the initial cane to the finished fibre is spread over two (or more) continuous stages, each of which is easier to manage as regards pressurisation than a single large drawdown. The approach might be described as a phased drawdown, in which the total drawdown ratio from initial preform or cane to finished fibre is implemented in two or more stages or phases within a same overall drawing procedure, each of which produces a fraction of the desired total drawdown. The retention of the initial preform or cane at the non-fibre end of the overall glass structure facilitates the application of pressure to the voids and allows for ease of handling, as compared to a narrower cane. When the intermediate cane has been consumed by the fibre drawing, a further portion of intermediate cane is drawn from the initial preform or cane, and the process continues. The reduced drawdown ratio offered by the intermediate cane going to the fibre provides a more manageable surface tension dynamic in the softened glass, enabling fibre geometries to be drawn that are otherwise unachievable if they were attempted to be drawn directly from the same initial preform. This is enhanced by a repeated replenishment of the intermediate cane from the initial preform or cane. This allows the entirety of the initial preform or cane (minus usual wastage) to be drawn into hollow core optical fibre, thereby greatly increasing the fibre yield for a given volume of initial preform or cane.

Consider the example of an antiresonant hollow core optical fibre in which the cladding comprises a single ring of spaced-apart and optionally nested capillaries or tubes arranged around the hollow core, as in FIGS. 2 and 3. The capillaries have a wall thickness (membrane thickness) which is selected based in the wavelengths of light the fibre is intended to guide, according to a relationship that defines low loss transmission windows between resonance wavelengths λₘ:

$${λ}_{m} \approx \frac{2 t \sqrt{{n}^{3} - 1}}{m} , m = 1 , 2 , 3 , …$$

where t is the wall thickness, n is the refractive index of the glass and m is the resonance order, with m=1 being generally preferred as providing the widest bandwidth transmission windows. High performing hollow core fibres have been developed for near-infrared propagation around 1550 nm, suitable for telecommunications applications. These fibres have a membrane thickness around 500 nm, and production is currently limited to single span lengths of around 10 km, owing the various difficulties in drawing hollow core optical fibre discussed above. We can define a membrane thickness of around 300 nm as a boundary between infrared fibres and shorter wavelength fibres, the latter being more difficult to fabricate. For guiding of shorter wavelengths in the visible and ultraviolet regions of the spectrum, over a useful transmission bandwidth, much thinner membranes are needed, of around 200 nm or less. In addition to this reduced membrane thickness, the overall cross-sectional structure of the fibre is smaller/narrower. Fabrication of such fibre by conventional drawing from standard preforms and canes designed for near-infrared hollow core fibres therefore requires a greatly increased drawdown ratio, which is difficult or impossible to achieve. The phased drawdown approach proposed herein addresses these issues.

As discussed above, current hollow core optical fibre designs, including HCPBF and ARF, require the application of pressure to the voids in the preform or cane during drawing. The pressurisation is often differential, in that two or more different pressures are applied to different voids. The pressures are required to counteract surface tension in the softened glass during drawing. This surface tension acts to shrink or collapse the voids and can alter or destroy the intended fibre structure if not checked by applied pressurisation. Adjustment of the pressure(s) can precisely control the final geometry of the fibre. During drawing, the glass structure undergoes a geometry change which is termed neckdown. This is a narrowing of the glass structure where it is softened and made pliable within the draw furnace, the width continuously decreasing over a length of the structure from the width of the preform or cane to the width of the fibre. When pressurisation is implemented, at the wider end (typically an upper end since fibre drawing is commonly carried out vertically) of the neckdown (closest to the pressure input at the open, non-drawn, end of the preform or cane) the geometry is dominated by the pressure. At the narrower end of the neckdown, where the fibre forms, the geometry is dominated by surface tension in the softened glass, which causes capillary contraction. Hence, an interplay exists between the forces of the applied pressures and the surface tension, and in order to achieve a desired capillary size and membrane thickness it is necessary to apply sufficient pressure that the capillary initially expands beyond the required size, in order that later contraction under the surface tension at the lower end of the neckdown pulls the capillary back to the target size.

Attempts to increase the fibre yield of a draw by using a wider preform or cane to increase the drawdown ratio so that more fibre can be produced from a preform or cane increases the complexity of the pressure-surface tension relationship and makes identifying the correct parameters for drawing more difficult. Eventually, the contraction phase of the draw dynamics becomes very aggressive, and increased capillary expansion under higher applied pressures is required to counteract it. However, within the glass structure, there is limited room for expansion of the capillaries, and there comes a point where the expansion overshoot required to pre-empt the contraction causes unacceptable deformations in the fibre structure. In particular, contact between neighbouring capillaries in an ARF design in which the capillaries should be spaced apart may occur, causing the capillaries to fuse together. In a HCPBF design, gross asymmetry of the hollow core can occur. Such defects are highly adverse to the optical properties and performance of the finished fibre, so need to be avoided. For convenience, the phenomenon may be termed mid-draw contact (MDC), and is a significant limiting factor in attempts to increase fibre yield for hollow core fibre production. For shorter wavelength fibres, the thinner membranes and smaller capillaries required are more sensitive to pressure and surface tension and the effects of MDC are further amplified, forcing the use of smaller drawdown ratios and a corresponding decrease in yield. If the proposed drawdown ratio from preform/cane to fibre is greater than the limits imposed by MDC, the intended fibre cannot be made.

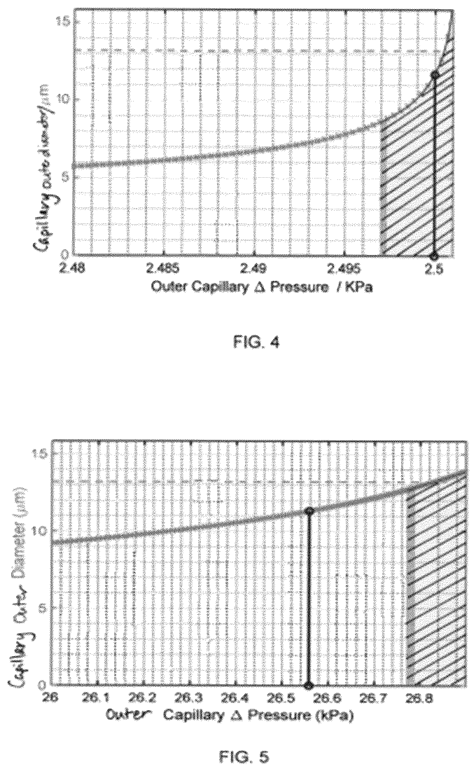

FIG. 4 shows a graph of the results of computer modelling of a fibre draw to form an ARF using a conventional draw from a preform or cane directly to the fibre with a single drawdown. The graph plots the variation of the outer diameter of a cladding capillary in a finished ARF fibre with a differential pressure applied to the capillary during drawing; higher differential pressures are required to expand to larger capillary sizes and thinner capillary membranes. The heavy vertical line shows a target diameter for the capillary of between 11 and 12 μm, corresponding to a capillary membrane thickness of 150 nm for light guiding in the ultraviolet-visible wavelength range, the particular fibre that was modelled. A differential pressure of 2.5 kPa is required to be applied to the capillary to achieve this target. The shaded region indicates where MDC occurs, with an onset at 2.497 kPa of applied pressure. Hence, the target fibre structure lies above the upper pressure limit for avoiding MDC, and the intended fibre cannot be made from the specified cane.

To address this, and overcome the limitations imposed by MDC, the proposed method introduces an intermediate stage in the draw, such that an initial cane or preform is firstly partially drawn into an intermediate narrower cane or preform, which is in turn drawn down further to form the fibre, while still unitary with the initial cane or preform, pressurisation being applied during at least the second draw phase, and optionally during the first draw phase.

FIG. 5 shows a graph of the results of computer modelling of a fibre draw to form the same ARF from the same initial cane or preform as in the FIG. 4 modelling, but modified by an additional intermediate draw stage. Since the preform/cane and the fibre are the same as in the FIG. 4 modelling, the overall drawdown ratio is the same, but the drawdown is split into two phases which are carried out in a single draw process, during which the initial preform/cane can remain rigged in the draw tower with pressurisation connections maintained. Again, the target capillary diameter of between 11 and 12 μm is indicated by a heavy vertical line. However, the target fibre structure now lies well below the differential pressure that marks the onset of MDC, shown by the shaded region. The target fibre is now obtainable at a differential pressure below the MDC threshold, and the intended fibre can be successfully fabricated from the specified cane. Note that the applied pressure differential required to produce the fibre is now 26.56 kPa, an order of magnitude higher than in the FIG. 4 model, but nevertheless, MDC contact is avoided. The higher pressure differential required to achieve the same fibre structure arises from the lower drawdown ratio from the initial preform, which enables drawing at a higher viscosity and corresponding higher draw tension. An increased viscosity requires more pressure to inflate the glass structure, but is acceptable because it is desirable to draw at as a high a tension as possible while avoiding breaks in the glass structure that occur if the tension is too high. High tension helps to maintain the required internal glass structure. Hence, the limitation imposed by MDC under a conventional draw regime is overcome, and the intended fibre can be successfully fabricated.

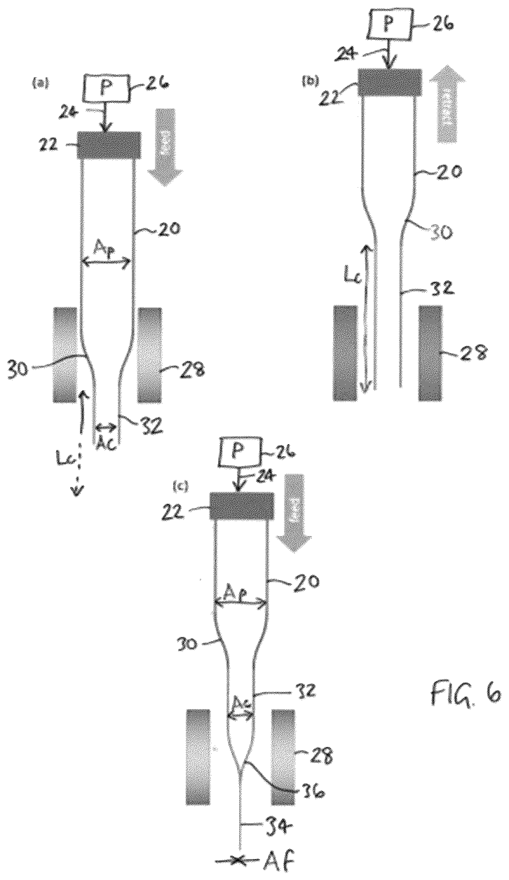

FIGS. 6(a)-6(c) show simplified schematic representations of an optical fibre drawing apparatus at stages in a hollow core fibre drawing method according to an example of the present disclosure. As a preliminary, the terms preform and cane will be discussed and defined. In optical fibre fabrication, a first step is the formation of a relatively large cylindrical glass structure, referred to as a preform. For a hollow core optical fibre, the preform has a cross-sectional structure containing glass elements that will, once drawn, form the structural elements required in the finished fibre, where fusion, expansions and contractions of the glass elements that occur during drawing are taken into account in the preform structure so that the final fibre structure is as intended. A preform is made by assembling its constituent glass elements into the appropriate arrangement. For a hollow core fibre, a preform is typically made by stacking a plurality of capillary tubes that will define the fibre cladding inside an outer glass tube that supports the cladding tubes, possibly with spacer elements to retain the capillary tubes in position. Bonding of the elements may be carried out to fix the capillary tubes in place relative to the outer tube, or the bonding may occur as part of the draw process. The preform may be drawn directly into the intended fibre. Alternatively, in conventional methods, the preform may be drawn into one or more separate canes, which have a width intermediate between the preform and the intended fibre, and a length of around one metre, for example. The canes may then each be drawn into separate lengths of the intended fibre. Canes may be simpler to handle than the preform, and also reduce the drawdown ratio for drawing into the fibre. The terms preform and cane tend to be used interchangeably to some extent, however, and hence require some clarification in the present context. A preform can be considered as any glass structure that can be drawn into a narrower structure (it is a pre-form of the form of the narrower structure). Under this definition, a preform made by stacking or other assembling of glass elements which is to be drawn into a cane or a fibre constitutes a preform, but similarly a cane can be considered to be a preform in that it can be drawn into a narrower cane or into a fibre. A cane is similarly a glass structure that can be drawn into a narrower structure (narrower cane or fibre), but it has been formed by being drawn from a wider glass structure, rather than by assembling the separate elements. For simplicity in the following description, the term “initial preform” will be used to denote the initial glass structure from which the draw process starts, with the understanding that it may comprise either a preform made by assembling glass elements into a required structure, or a cane which has been drawn from such a preform. The term “intermediate cane” will be used to denote the glass structure of intermediate width which is drawn from the initial preform, with the descriptor “intermediate” indicating a difference from a conventional cane which is separated from its originating preform before being drawn into fibre. In the current context the intermediate cane remains unitary with the initial preform during drawing of fibre from the intermediate cane. The term “fibre” is used conventionally to denote optical fibre which is drawn from the intermediate cane.

The initial preform has a preform width or diameter (first width), the intermediate cane has a cane width or diameter (second width) less than the preform width, and the fibre has a fibre width or diameter (third width) less than the cane width. The overall drawdown ratio of the fibre drawing method is the ratio of the preform glass cross-sectional areas to the fibre glass cross-sectional area. The overall drawdown ratio is implemented in stages or phases comprising a cane drawdown ratio being the ratio of the preform glass cross-sectional area to the cane glass cross-sectional area and a fibre drawdown ratio being the ratio of the cane glass cross-sectional area to the fibre glass cross-sectional area width.

FIG. 6(a) shows the apparatus, being an optical fibre drawing tower, during a first stage of the method in which an intermediate cane is drawn from an initial preform. The initial preform 20 has a transverse cross-sectional structure comprising glass elements and voids configured and arranged to transform into the required hollow core and microstructured cladding (so, a transverse cross-sectional structure comprising a hollow core surrounded by a plurality of voids defining the microstructured cladding) under the action of drawing and applied pressure in the voids, as is well-known. Typically, it will have a length in the range of about 1 m to 3 m, although the invention is in no way limited in this regard. In this example, the drawing is to be performed in a conventional vertical fibre drawing tower, so an upper end of the initial preform 20 is mounted on a support structure or rig 22, commonly referred to as a preform chuck, which is configured to suspend the initial preform 20 vertically, hanging freely from its upper end. The rig 22 is configured to enable the connection of gas supply lines from a pressurised gas source 26 to the voids in the initial preform 20 during at least part of the draw process, so as to apply one or more pressures P to the voids. The gas source 26 is under control of a controller (not shown) so that the differential pressure applied to the voids may be turned on, off or adjusted during the draw.

A lower end of the initial preform 20 is placed in a fibre draw furnace 28, which is conventionally an annular furnace mounted vertically so that the initial preform 22 is inserted vertically into the central aperture of the furnace 28, so that a lower end portion of the initial preform 20 is inside the furnace 28. The initial preform 20 has an initial preform width and a glass cross-sectional area Ap.

A first stage of the actual draw may then be carried out. The furnace 28 is operated in order to heat the portion of the initial preform 20 within it and soften the glass of that portion. The softened glass is drawn from the lower end of the initial preform 20 to form, via a first neckdown 30, a structure of narrower width and a smaller glass cross-sectional area Ac, in this case the intermediate cane 32, in the usual manner. The draw may be carried out under gravity, or more usually, with tensioning applied to the lower end of the intermediate cane 32. As the softened lower portion of the initial preform 20 is converted into the intermediate cane 30, the initial preform 20 is lowered by downward movement of the rig 22 so that further portions of it are located inside the furnace 28 and softened for drawing into the intermediate cane 30. The initial preform 20 is gradually fed into the furnace 28 (by moving the initial preform axially towards the furnace) until a predetermined portion of it has been drawn into the intermediate cane 32, which has a length Lc. Pressure may or may not be applied to the voids of the initial preform 20 during drawing of the intermediate cane 32. If the cane drawdown ratio Ap:Ac is not very large, pressurisation may not be needed to maintain the proper shape and size of the voids. In other cases, pressurisation from the gas source 26 may be required, for example if the cane drawdown ratio is relatively large or if a particular size of voids is required in the initial cane 32 in order to achieve a specified void size or wall thickness in the finished fibre.

FIG. 6(b) shows a next step in the method. Once the length Lc of intermediate cane 32 has been drawn, the temperature of the furnace 28 is lowered by turning the furnace 28 to idle, for cooler operation at which the glass does not deform (hence, the furnace is rendered inoperable as far as enabling drawing is concerned). The movement of the rig 22 is reversed so that the suspended initial preform 20, with the intermediate cane 32 extending from its lower end so that the initial preform 20 and the intermediate cane 32 form a unitary structure, is retracted upward (the initial preform 20 is moved axially away from the furnace), and the first neckdown 30 is withdrawn from the furnace 28. The retraction is continued until a portion of the intermediate cane 30 which is spaced from the first neckdown 30 is located within the furnace 28. Preferably this is a lower or lowest portion of the intermediate cane 30, since glass extending below the furnace 28 cannot be heated and drawn into fibre and is hence wasted. The length Lc of the intermediate cane 32 which is formed in the first draw stage may be determined by the dimensions of the draw tower and the range of vertical movement of the rig 22. Conveniently, the length Lc is set so that the rig 20 is able to elevate the initial preform 20 sufficiently such that the lower end of the intermediate cane 32 is positioned within the furnace 28, in order that wastage of lower parts of the intermediate cane 32 is minimised. On the other hand, a longer length of intermediate cane 32 increases the amount of fibre that can be produced at one time in the second stage of the draw (described below) and minimises the number of draw cycles required to consume the initial preform 20 in the finished fibre. So, usefully, the maximum length of intermediate cane 32 that can be accommodated by the raised rig 22 can beneficially be made. However, in the event that a very long length can be accommodated, the ability of the pressure system at the rig 22 to properly apply the required differential pressure for the second draw stage to the lower end of the intermediate cane 32, which is remote from the rig 22, may be inhibited since the applied gas has further to travel along narrow voids that impose a pressure drop over distance, so this may alternatively impose an upper limit on the length Lc. Typically, however, it is expected that a practical range of lengths for the intermediate cane 32 will be in the range of about 1 m to 10 m.

FIG. 6(c) shows a second stage of the actual draw. Once the relevant portion of the intermediate cane 30 is located inside the furnace 28, differential pressure is applied from the pressure system at the rig 22, to extend along the voids in the initial preform 20 and into those of the intermediate cane 32. The furnace 28 is activated so that heat is applied to the intermediate cane 32 and the glass in its lower portion is softened. The required hollow core optical fibre 34 is then drawn from the softened glass, which forms a second neckdown 36 at the bottom of the intermediate cane 32. The fibre 32 may be drawn under gravity or under tension, as required in the usual manner, and can be collected by being wound onto a spool or bobbin (not shown). The fibre 34 has a fibre width and a glass cross-sectional area Af, so that the fibre drawdown ratio achieved in the second stage draw is Ac:Af. As the intermediate cane 32 is converted into the fibre 34, the rig 22 is operated to move downwards and feed the intermediate cane 32 gradually into the furnace 28 so that fibre 34 can continue to be drawn.

Once the intermediate cane 32 has been wholly or partially consumed, and the first neckdown 30 approaches the second neckdown 36, the second draw stage is stopped. A length of the hollow core optical fibre 34 has been drawn, and may be separated from the intermediate cane. A complete draw cycle has been completed, comprising formation of the intermediate cane 32 from the initial preform 20 followed by formation of the fibre 34 from the intermediate cane 32. A second cycle can now commence, in which more intermediate cane 32 is produced. The pressurisation regime of the second draw stage is switched off, and replaced by the pressurisation regime of the first draw stage, if any. The furnace 28 is switched to idle in order to allow repositioning of the rig, which is moved downward to locate the first neckdown 30 (more generally, the end portion of the initial preform 20 in the vicinity of the first neckdown 30) inside the furnace 28, as in FIG. 6(a). The furnace 28 is reactivated in order to soften the glass at or near the first neckdown, and the first draw stage is repeated, in order to draw more intermediate cane 32 from the initial preform 20, replenishing or restoring the length previously consumed by drawing the fibre 34. Once a further length Lc of the intermediate cane 32 has been produced, the furnace is switched to idle again, the rig retracted upwards to position the second neckdown 36 (more generally, a portion of the intermediate cane in the vicinity of the second neckdown 36) in the furnace, the pressurisation regime for the second draw stage is reapplied, the furnace 28 activated, and drawing of the fibre 34 recommences. If the previously drawn length of fibre 34 was separated from the intermediate cane, this fibre draw produces a new length of fibre. If the previously drawn length of fibre 34 was not separated from the intermediate cane 32, the new fibre draw increases the fibre length. This completes the second cycle, and successive cycles can be repeated until the initial preform is fully consumed (minus the usual draw wastage, in other words, the accessible or usable glass of the initial preform is used up), and has been converted into a multiple lengths or a continuous length of fibre 34, collected on one or more spools. In this way, a large overall drawdown ratio Ap:Af can be achieved, enabling a high fibre yield. Fibre production efficiency is thereby enhanced. Additionally, as noted above, the division of the drawdown ratio into smaller steps overcomes surface tension and pressure dynamic problems that can prevent fibre fabrication at a single large drawdown ratio, enabling the fabrication of narrower fibres with thinner membranes able to propagate visible and ultraviolet wavelengths.

Although not mentioned above, the initial preform may include an outer glass jacket layer surrounding the preform structure, in order to produce a finished fibre with an outer glass jacket, as is conventional. Typically, the preform structure for defining the cross-sectional structure of the fibre will be inserted into a larger outer glass tube before drawing, the outer glass tube providing the jacket layer. The heating of the draw process fuses the glass of the jacket around the inner structure, to form a unitary jacketed fibre. This is conventional in a regular fibre drawing, where a preform or a cane is drawn directly into the fibre. In this circumstances, the outer glass tube is added around the preform or cane before drawing, and becomes a fused outer layer only during drawing of the fibre. In contrast, under the presently proposed method, the outer glass tube is placed around the initial preform, so is present as the intermediate cane is drawn from the initial preform. The glass for the jacket layer therefore becomes a fused outer layer, fused around the intermediate cane, during the first draw stage. The jacket is therefore already a fused layer before the fibre is drawn. Thus, the intermediate cane differs from a regular cane in that it includes a jacket as a fused layer, whereas a regular cane receives an outer glass tube as a jacket and the two are not fused together.

Note that the thickness of the jacket layer, at initial preform stage, intermediate cane stage or fibre stage, may or may not contribute to the glass cross-sectional areas from which the drawdown ratio is calculated; the mathematical result is the same for both approaches.

As a practical example, the inventors have used the above-described modified fibre drawing process to fabricate fibre with the aim of achieving hollow core ARF with membrane thicknesses less than 200 nm and therefore suitable for visible and ultraviolet wavelength propagation. An initial preform of diameter about 3.8 mm (actually a cane previously drawn from a preform, and located in an outer jacket tubular layer with an outer diameter of 28 mm) was used, originally designed to produce fibres with thicker membranes, and having a structure with single ring of capillaries. The initial preform was drawn into an intermediate cane of diameter about 1 mm, with a fused jacket as described above having an outer diameter of 6.6 mm which was then drawn into fibre, applying appropriate pressurisation. A yield in excess of 3 km of fibre was achieved, with a membrane thickness around 170 nm inferred from transmission measurements.

The detailed description above includes a single intermediate stage of forming an intermediate cane between the initial preform and the fibre. However, additional intermediate stages may be included if preferred, to provide a series of additional intermediate canes, each with a width less than that of the preceding intermediate cane. This will divide the overall drawdown ratio into more fractions of smaller drawdown ratios, which may be beneficial if larger ratios are not preferred, for example if pressurisation at any stage is simpler to achieve for smaller ratios. To implement additional stages, the intermediate cane may be a first intermediate cane of cross-sectional area Ac1, which is drawn into a narrower second intermediate cane of glass cross-sectional area Ac2 less than Ac1, which may when be drawn into a still narrower third intermediate cane of glass cross-sectional area Ac3 less than Ac2, and so on to an nth intermediate cane of glass cross-sectional area Acn which is greater than the fibre glass cross-sectional area Af, where n is 2 or greater. Each of these intermediate cane drawings may be pressurised or not. The final or last of the intermediate canes is then drawn into the fibre, before being replenished by drawing from the preceding intermediate cane and so on back to replenishment of the first intermediate cane from the initial preform.

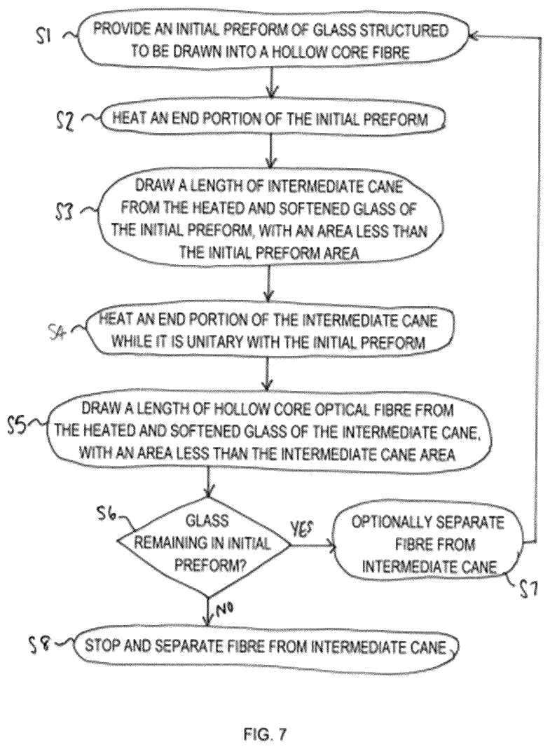

FIG. 7 shows a flow chart of steps in an example fibre drawing method according to the present disclosure. In a first step S1, a glass initial preform is provided, configured and structured for drawing into a hollow core fibre. In a second step S2, an end portion of the initial preform is heated in order to soften the glass in the portion, to make it malleable for drawing. In a third step S3, a first draw stage is implemented, at a first drawdown ratio, in which a length of intermediate cane is drawn from the softened glass of the initial preform, the intermediate cane having width and a glass cross-sectional area which are less than the width and the glass cross-sectional area of the initial preform. The method moves to fourth step S4, in which the intermediate cane, while remaining attached to the initial preform, has its end portion (remote from the initial preform) heated in order to soften the glass and make it malleable for drawing. This might be achieved by retracting the initial preform from a furnace in which the heating of step S2 is carried out, in order to locate the end portion of intermediate cane in the furnace, but other arrangements may be used as convenient according to the available apparatus. In a fifth step S5, a second draw stage is implemented, at a second drawdown ratio, in which a length of hollow core optical fibre is drawn from the softened glass of the intermediate cane, the fibre having a width and a glass cross-sectional area which are less than the width and the glass cross-sectional area of the intermediate cane. Differential pressurisation may be applied via voids in the initial preform during the second draw stage, or both the first and the second draw stage. The method proceeds to a decision step S6, where it is determined if there is glass remaining in the initial preform for further drawing. If there is more glass available, the method proceeds to an optional step S7 in which the drawn fibre is separated from the intermediate cane. If it is preferred that the already-achieved fibre length is increased by a further draw, this separation is omitted. Then the method loops back to repeat steps S2 to S5, in order to draw more fibre, either as a new separate length or to extend the existing length. If all available glass from the initial preform has been consumed (or alternatively, a required amount of fibre has been produced), the method terminates in a last step S8, in which heating and drawing ceases, and the most recently drawn length of fibre, or portion of the overall length, is separated from the intermediate cane. Thus, a total length of fibre is produced from the initial preform, as plurality of individual lengths from each fibre draw stage, or a continuous single length accumulated over a plurality of fibre draw stages.

Although the methods have thus far been described as being performed in a conventional optical fibre drawing tower, the invention is not limited in this regard and the heating and drawing of the glass structure may be carried out using other apparatus as preferred. However, given the ability of the methods to increase fibre yield so that large continuous lengths of hollow core optical fibre can be readily produced, use of a drawing tower is particularly convenient. Indeed, a benefit of the proposed methods is that they can be readily implemented using conventional fibre drawing apparatus.

As explained above, the described methods propose modification of the drawing of hollow core optical fibres by dividing the drawdown into two or more stages, which enables access to larger overall drawdown ratios than previously available. This enables benefits including increased fibre yield from a single initial preform, longer continuous lengths of fibre, improved production efficiency, and enhanced fabrication of fibres with thinner membranes. Conventionally, achievable drawdown ratios for hollow core fibre drawing have been in the range of about 500 to 20,000, where the drawdown ratio is the ratio of the total cross-sectional area of glass in the preform to the total cross-sectional area of glass in the fibre. This is based on typical preform widths in the range of about 6 mm to 30 mm, where this is the outer jacket width, the internal preform cladding width being about 20 to 40% of the outer width, and typical fibre widths in the range of about 100 μm to 500 μm. In contrast, the proposed technique enables the use of a greatly increased total drawdown ratio (glass cross-sectional area of initial preform to glass cross-sectional area of finished fibre) in the range of 10,000 to 3,000,000, but divided over two or more smaller drawdown ratios (noting that the overall drawdown ratio is the product of the two or more smaller drawdown ratios). The division can between any fraction of the total drawdown ratio. In the case of two drawdowns, namely a first drawdown from initial preform to intermediate cane followed by a second drawdown intermediate cane to finished fibre, it is anticipated that the first drawdown ratio may be in the range of 10 to 150, and the second drawdown ratio might be in the range of 1,000 to 20,000, although this is purely exemplary, and other ranges for each of the two drawdown ratios are not excluded. It is envisaged that a larger fraction of the total drawdown ratio may be implemented in the second stage of the drawing process while keeping the drawdown ratio low enough to avoid MDC. This enables longer spans of fibre from a given length of intermediate cane, where the achievable length of intermediate cane might be limited by practical considerations such as the height of an available fibre drawing tower.

For the fabrication of infrared hollow core ARF optical fibres, with membranes of thickness in the range of about 300 nm to 2500 nm, total drawdown ratios from initial preform to finished fibre are anticipated to be achievable in the range of 200,000 to 1,000,000, with the width of the initial preform being in the range of 20 mm to 200 mm. This contrasts with current typical much smaller preform widths of about 10 mm to 20 mm and correspondingly limited drawdown ratios of about 2,000 to 10,000. These types of hollow core fibre have widths in the range of about 150 μm to 500 μm.

For the fabrication of ultraviolet and visible hollow core ARF optical fibres, with membranes of thickness in the range of 50 nm to 300 nm, total drawdown ratios from initial preform to finished fibre are anticipated to be achievable in the range of 20,000 to 3,000,000 or above, with the width of the initial preform being in the range of about 6 mm to 200 mm. These types of hollow core fibre have widths in the range of about 50 μm to 250 μm. Currently, it is impractical to fabricate these types of fibre with conventional fibre drawing, owing to a need for extremely high draw tensions with accompanying increased frequency of fibre breaks and consequent limitation in collectable fibre yield, or the use of very small initial preforms which also limit the fibre yield and make pressurisation during drawing more difficult.

However, these drawdown ratios are examples only, and larger values may be accessible with careful control of the pressurisation regime and other operational parameters of the drawing tower such as furnace temperature, drawing tension and drawing speed.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1]G T Jasion et al, “Fabrication of tubular anti-resonant hollow core fibers: modelling, draw dynamics and process optimization.” Opt. Express vol. 27, 20567-20582 (2019).
[2]Y Chen et al, “Multi-kilometer long, longitudinally uniform hollow core photonic bandgap fibers for broadband low latency data transmission,” IEEE JLT, 34, pp104-113, (2016).
[3]U.S. Ser. No. 11/203,547
[4]F Yu et al, “Single-mode solarization-free hollow-core fiber for ultraviolet pulse delivery”, Opt. Express, vol. 26, 10879-10887 (2018)
[5]S F Gao et al, “Hollow-core conjoined-tube negative-curvature fibre with ultralow loss”, Nat. Commun, 9, p2828 (2018).
[6] CN 111474628

1. A method of fabricating a hollow core optical fibre, the method comprising:
providing an initial preform formed from glass and having a transverse cross-sectional structure configured to form, in an optical fibre drawn from the initial preform, a transverse cross-sectional structure comprising a hollow core surrounded by a plurality of voids defining a microstructured cladding, the initial preform having a first glass cross-sectional area;
heating an end portion of the initial preform in order to soften the glass of the end portion;
drawing a length of intermediate cane from the softened glass of the initial preform, via a first neckdown, the intermediate cane having a second glass cross-sectional area less than the first glass cross-sectional area;
heating a portion of the intermediate cane spaced from the first neckdown in order to soften the glass of the portion, the intermediate cane remaining unitary with the initial preform; and
drawing a length of hollow core optical fibre from the softened glass of the intermediate cane, via a second neckdown, the hollow core optical fibre having a third glass cross-sectional area less than the second glass cross-sectional area.

2. A method according to claim 1, further comprising, after drawing the length of hollow core optical fibre from the softened glass of the intermediate cane, performing the following steps:
heating the end portion of the initial preform at or near the first neckdown to soften the glass of the end portion;
drawing the intermediate cane from the softened glass of the initial preform in order to restore the length of intermediate cane;
heating the intermediate cane at or near the second neckdown to soften the glass of the intermediate cane; and
drawing a further length of the hollow core optical fibre from the softened glass of the intermediate cane.

3. A method according to claim 2, further comprising repeating the steps of claim 2 until a desired total length of the hollow core fibre has been drawn and/or all usable glass of the initial preform has been consumed.

4. A method according to claim 1, further comprising applying one or more pressures to voids in the transverse cross-sectional structure of the initial preform during the drawing of the hollow core optical fibre.

5. A method according to claim 4, further comprising applying one or more pressures to the voids in the transverse cross-sectional structure of the initial preform during the drawing of the intermediate cane.

6. A method according to claim 1, further comprising separating the length of the hollow core fibre from the intermediate cane.

7. A method according to claim 1, wherein the method is performed in an optical fibre drawing tower, a furnace of the optical fibre drawing tower providing the heating.

8. A method according to claim 7, wherein drawing the intermediate cane and drawing the hollow core optical fibre include movement of the initial preform in an axial direction towards the furnace in order to provide heating and softening of additional glass.

9. A method according to claim 8, further comprising, after drawing of the intermediate cane, movement of the initial preform in an axial direction away from the furnace in order to position the intermediate cane in the furnace for heating.

10. A method according to claim 1, wherein the length of the intermediate cane is in the range of 1 m to 10 m.

11. A method according to claim 1, wherein the first glass cross-sectional area and the third glass cross-sectional area define an overall drawdown ratio of first glass cross-sectional area:third glass cross-sectional area in the range of 10,000 to 3,000,000.

12. A method according to claim 1, wherein the first glass cross-sectional area and the second glass cross-sectional area define a first stage drawdown ratio of first glass cross-sectional area:second glass cross-sectional area in the range of 10 to 150, and the second glass cross-sectional area and the third glass cross-sectional area define a second stage drawdown ratio of second glass cross-sectional area:third glass cross-sectional area in the range of 1,000 to 20,000.

13. A method according to claim 1, wherein the first glass cross-sectional area and the second glass cross-sectional area define a first stage drawdown ratio of first glass cross-sectional area:second glass cross-sectional area, and the second glass cross-sectional area and the third glass cross-sectional area define a second stage drawdown ratio of second glass cross-sectional area:third glass cross-sectional area, the first stage drawdown ratio being smaller than the second stage drawdown ratio.

14. A method according to claim 1, further comprising surrounding the initial preform with a glass outer layer before heating the end portion of the initial preform, so that the intermediate cane is drawn fused with the glass outer layer, the outer glass layer intended as a jacket for the hollow core optical fibre.

15. A method according to claim 1, further comprising drawing one or more additional intermediate canes from the intermediate cane before drawing the hollow core optical fibre from a last of the additional intermediate canes, each additional intermediate cane having a glass cross-sectional area less than a glass cross-sectional area of the preceding intermediate cane.

16. A method according to claim 1, wherein the hollow core optical fibre is drawn to a membrane thickness between voids in the hollow core optical fibre greater than 200 nm.

17. A method according to claim 1, wherein the hollow core optical fibre is drawn to a membrane thickness between voids in the hollow core optical fibre of 200 nm or less.

18. A hollow core optical fibre fabricated using a method according to claim 1.
